(19) United States
(12) Patent Application Publication
(10) Pub. No.: US 2025/0370176 A1
(43) Pub. Date: Dec. 4, 2025

(54) OPTICAL MEMBER AND DISPLAY APPARATUS INCLUDING THE SAME

(71) Applicant: SAMSUNG SDI CO., LTD., Yongin-si (KR)

(72) Inventors: Irina NAM, Suwon-si (KR); Tae Ji KIM, Suwon-si (KR); Dong Heon YUN, Suwon-si (KR); Won KIM, Suwon-si (KR); II Jin KIM, Suwon-si (KR)

(21) Appl. No.: 19/221,863

(22) Filed: May 29, 2025

(30) Foreign Application Priority Data
May 29, 2024 (KR) 10-2024-0069930

(51) Int. Cl. G02B 5/22; G02B 1/04

(52) U.S. Cl. CPC G02B 5/223; G02B 1/04

(57) ABSTRACT

An optical member, including an adhesive layer, and a transmittance control layer and a base film sequentially on an upper surface of the adhesive layer, wherein the transmittance control layer includes a (meth)acrylic copolymer and a dye mixture, the dye mixture includes a first dye having a maximum absorption wavelength of 400 nm to 440 nm, a second dye having a maximum absorption wavelength of 480 nm to 520 nm, a third dye having a maximum absorption wavelength of 570 nm to 610 nm, and a fourth dye having a maximum absorption wavelength of 650 nm to 700 nm, and the (meth)acrylic copolymer is a copolymer of a monomer mixture including 50 mol % to 90 mol % of an alkyl group-containing (meth)acrylic monomer and 10 mol % to 50 mol % of an aromatic group-containing (meth)acrylic monomer, all mol % being based on 100 mol % of the monomer mixture.

### CROSS-REFERENCE TO RELATED APPLICATION

The present application claims priority and the benefit of Korean Patent Application No. 10-2024-0069930, filed on May 29, 2024, in the Korean Intellectual Property Office, the entire disclosure of which is incorporated herein by reference.

### BACKGROUND

### 1. Field

Embodiments relate to an optical member and a display apparatus including the same.

### 2. Description of the Related Art

Light emitting displays, including organic light emitting displays or the like, may not require a polarizing plate. However, such a light emitting display may have poor screen quality due to total reflection of external light at a surface of a panel therein. Therefore, it is common for light emitting displays to have a polarizing plate on an upper surface of a panel. The polarizing plate may include, e.g., a polarizer and a retardation film. In addition, the polarizing plate may contain a UV absorber to help prevent damage to a light emitting device due to external light.

### SUMMARY

The embodiments may be realized by providing an optical member, including an adhesive layer, and a transmittance control layer and a base film sequentially on an upper surface of the adhesive layer, wherein: the transmittance control layer includes a (meth)acrylic copolymer and a dye mixture, the dye mixture includes a first dye having a maximum absorption wavelength of 400 nm to 440 nm, a second dye having a maximum absorption wavelength of 480 nm to 520 nm, a third dye having a maximum absorption wavelength of 570 nm to 610 nm, and a fourth dye having a maximum absorption wavelength of 650 nm to 700 nm, and the (meth)acrylic copolymer is a copolymer of a monomer mixture including 50 mol % to 90 mol % of an alkyl group-containing (meth)acrylic monomer and 10 mol % to 50 mol % of an aromatic group-containing (meth)acrylic monomer, all mol % being on 100 mol % of the monomer mixture.

The alkyl group-containing (meth)acrylic monomer and the aromatic group-containing (meth)acrylic monomer may be included in a total amount of 95 mol % or more, based on 100 mol % of the monomer mixture.

The alkyl group-containing (meth)acrylic monomer may have a homopolymer glass transition temperature of 50° C. or more.

The aromatic group-containing (meth)acrylic monomer may have a homopolymer glass transition temperature of 5° C. or more.

The aromatic group-containing (meth)acrylic monomer may include a (meth)acrylic acid ester containing two or more aromatic groups at an ester site thereof.

The two or more aromatic groups may be biphenyl groups.

The (meth)acrylic copolymer may be a copolymer of methyl (meth)acrylate and biphenylylmethyl (meth)acrylate.

The (meth)acrylic copolymer may have a glass transition temperature of 35° C. to 70° C.

The (meth)acrylic copolymer may have a weight average molecular weight of 100,000 g/mol to 500,000 g/mol.

The first dye may include a dialkoxy group-substituted porphyrin dye.

The second dye may include a substituted boron dipyrromethene dye.

The third dye may include a tetraazaporphyrin dye.

The fourth dye may include a sulfonamide group-substituted copper complex dye.

The dye mixture including the first dye, the second dye, the third dye, and the fourth dye may be included in an amount of 3 wt % to 15 wt %, based on a total weight of the transmittance control layer.

The transmittance control layer may include 0.001 wt % to 5 wt % of the first dye, 0.001 wt % to 5 wt % of the second dye, 0.001 wt % to 5 wt % of the third dye, and 0.001 wt % to 5 wt % of the fourth dye, all wt % being based on a total weight of the transmittance control layer.

The the transmittance control layer may have a thickness of 0.1 μm to 10 μm.

The base film may be free from an antireflection layer.

The adhesive layer may include a UV absorber.

The embodiments may be realized by providing the optical display apparatus comprising the optical member according to an embodiment.

The optical display apparatus may be free from a polarizing plate.

### DETAILED DESCRIPTION OF THE DRAWINGS

Features will become apparent to those of skill in the art by describing in detail exemplary embodiments with reference to the attached drawings in which:

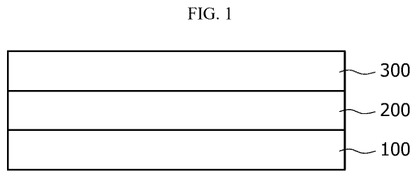

FIG. 1 is a cross-sectional view of an optical member according to one embodiment.

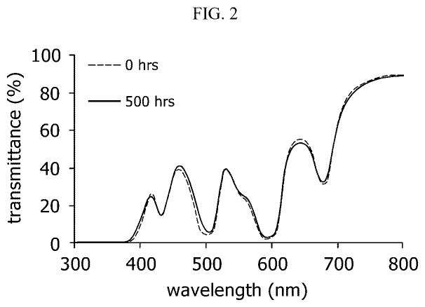

FIG. 2 is a graph depicting light transmittance of an optical member of Example 1 as a function of wavelength.

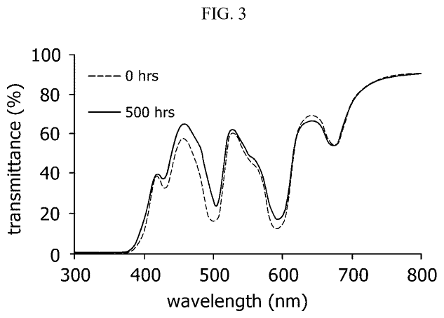

FIG. 3 is a graph depicting light transmittance of an optical member of Comparative Example 1 as a function of wavelength.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

The terminology used herein is for the purpose of describing exemplary embodiments and is not intended to limit the present invention. Herein, the singular forms “a”, “an”, and “the” are intended to include the plural forms as well, unless the context specifically indicates otherwise. As used herein, the term “or” is not necessarily an exclusive term, e.g., “A or B” would include A, B, or A and B.

Herein, “homopolymer glass transition temperature” may refer to a glass transition temperature (Tg) measured on a homopolymer of a target monomer using a differential scanning calorimeter (Discovery, TA Instruments Inc.). Specifically, the homopolymer of the target monomer is heated to 180° C. at a heating rate of 20° C./min, cooled gradually to −100° C., and heated to 100° C. at a heating rate of 10° C./min to obtain data on an endothermic transition curve, followed by determining the glass transition temperature by an inflection point of the endothermic transition curve.

Herein, “light transmittance” refers to total luminous transmittance.

Herein, “light emitting device” may include, e.g., an organic or organic/inorganic hybrid light emitting device and may refer to a device including a light emitting diode (LED), an organic light emitting diode (OLED), a quantum dot light emitting diode (QLED), a light emitting material, such as a phosphor, or the like.

Herein, “(meth)acryl” refers to acryl and/or methacryl.

Herein, “maximum absorption wavelength” refers to a wavelength at which a maximum absorbance appears in measurement of absorbance of a dye solution in which a dye is dissolved at a concentration of 10 ppm in methyl ethyl ketone. The absorbance may be measured by a typical method known in the art.

As used herein to represent a specific numerical range, the expression “X to Y” means “greater than or equal to X and less than or equal to Y (X≤ and ≤Y)”.

In accordance with an embodiment, an optical member may be provided. The optical member may be used in an optical display apparatus without a polarizing plate including a polarizer, e.g., a light emitting device display without a polarizing plate.

In accordance with an implementation, the optical member may have, e.g., a low light transmittance variation at a wavelength of 380 nm even after long-term exposure to UV light under repeated temperature changes between ambient temperature and high temperature. This indicates that the optical member may help prevent damage to a light emitting device due to external light even after long-term exposure to UV light and under repeated temperature changes between ambient temperature and high temperature.

In this regard, the optical member may have a light transmittance variation ΔT(λ) of 7% or less, as calculated according to Equation 1. Within this range, the optical member may help reduce damage to a light emitting device even after long-term exposure to UV light, thereby helping improve lifespan of a light emitting device display.

$$\begin{matrix}[ Equation l ] & \\ △T ( λ ) = \vert {T}_{2} ( λ ) - {T}_{1} ( λ ) \vert , & ( 1 )\end{matrix}$$

In Equation 1, T₁(λ) may be, e.g., a light transmittance (unit: %) of the optical member at a wavelength λ (nm) in the range of, e.g., 400 nm to 585 nm and T₂(λ) may be a light transmittance (unit: %) of the optical member at a wavelength λ (nm) in the range of, e.g., 400 nm to 585 nm, as measured after a total of 500 hours of multicycle light irradiation, wherein one cycle may be defined as irradiating the optical member with 340 nm light at an irradiance of 0.35 W/m² for 12 hours while leaving the optical member at 25° C. for 4 hours and at 63° C. for 8 hours.

In an implementation, the optical member may have a light transmittance variation of, e.g., 7% or less at each of 405 nm, 493 nm, or 585 nm wavelengths, as calculated according to Equation 1.

In an implementation, the optical member may have a light transmittance variation of 6% or less at each of 405 nm, 493 nm, and 585 nm wavelengths, as calculated according to Equation 1.

In an implementation, T₁(λ) in Equation 1 may be 15% or less, e.g., 1% to 15%.

In an implementation, T₂(λ) in Equation 1 may be 15% or less, e.g., 4% to 15%.

Now, an optical member according to one embodiment will be described.

The optical member may include, e.g., an adhesive layer and a transmittance control layer and a base film sequentially on an upper surface of the adhesive layer, wherein the transmittance control layer may include, e.g., a (meth)acrylic copolymer and a dye mixture. Here, the dye mixture may include, e.g., a first dye having a maximum absorption wavelength of 400 nm to 440 nm, a second dye having a maximum absorption wavelength of 480 nm to 520 nm, a third dye having a maximum absorption wavelength of 570 nm to 610 nm, and a fourth dye having a maximum absorption wavelength of 650 to 700 nm, and the (meth)acrylic copolymer may be, e.g., a copolymer of a monomer mixture including 50 mol % to 90 mol % of an alkyl group-containing (meth)acrylic monomer and 10 mol % to 50 mol % of an aromatic group-containing (meth)acrylic monomer, all mol % being based on 100 mol % of the monomer mixture.

The optical member may further include, e.g., a release film on the other surface of the adhesive layer to protect the adhesive layer. For example, the release film may be on the adhesive layer on the side opposite to the side that the control layer and the base film are on.

In the following, each component of the optical member will be described in detail.

### Adhesive Layer

The adhesive layer may be used to help adhesively attach the optical member to a panel for optical display apparatuses. The adhesive layer may include, e.g., a cured product of a composition described below.

In an implementation, the cured product may be a thermally cured product of the composition described below.

The composition may include, e.g., a UV absorber and a (meth)acrylic copolymer.

The UV absorber may absorb light in the wavelength range of, e.g., 360 nm to 410 nm. The UV absorber may significantly help prevent damage to a light emitting device due to external light through absorption of light in the wavelength range of 360 nm to 410 nm.

In an implementation, the UV absorber may include, e.g., an indole UV absorber.

The indole UV absorber may have, e.g., a low light transmittance not only at a wavelength of 360 nm to 410 nm but also at a wavelength of 400 nm to 405 nm, as compared to other types of UV absorbers, and thus may help sufficiently suppress damage to a light emitting device. In an implementation, the optical member including the indole UV absorber may have a light transmittance of 5% or less, e.g., 0% to 5%, at a wavelength of 405 nm.

In an implementation, the indole UV absorber may include, e.g., a compound represented by Formula 1:

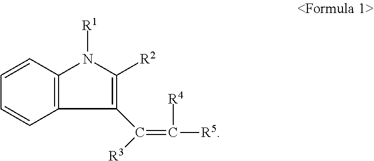

In Formula 1, R¹ may be or include, e.g., hydrogen or a substituted or unsubstituted C₁ to C₁₀ alkyl group.

R² may be or include, e.g., hydrogen or a substituted or unsubstituted C₆ to C₂₀ aryl group.

R³ may be or include, e.g., hydrogen or a substituted or unsubstituted C to C₁₀ alkyl group.

R⁴ may be or include, e.g., hydrogen, a cyano group (CN), or a substituted or unsubstituted C₁ to C₁₀ alkyl group.

R⁵ may be or include, e.g., a cyano group or —(C═O)O—R⁶, wherein R⁶ may be, e.g., a substituted or unsubstituted C₁ to C₁₀ alkyl group or a substituted or unsubstituted C₆ to C₂₀ aryl group.

In an implementation, R¹ may be, e.g., a C₁ to C₅ alkyl group, e.g., a methyl group, R² may be, e.g., a C₆ to C₁₀ aryl group, e.g., a phenyl group, R³ may be, e.g., hydrogen or a C₁ to C₅ alkyl group, e.g., hydrogen, R⁴ may be, e.g., a cyano group, and R⁵ may be, e.g., a cyano group or —(C═O)—O—R⁶, wherein R⁶ may be, e.g., a substituted or unsubstituted C₁ to C₈ alkyl group. In an implementation, the compound represented by Formula 1 may include, e.g., a compound represented by Formula 1-1 or a compound represented by Formula 1-2.

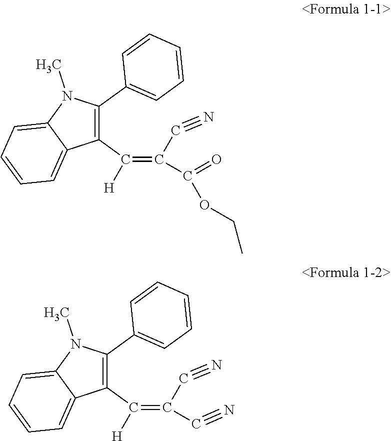 [SMILES: CCOC(=O)/C(C#N)=C/c1c(-c2ccccc2)n(C)c2ccccc12 ; Cn1c(-c2ccccc2)c(C=C(C#N)C#N)c2ccccc21]

In an implementation, the compound represented by Formula 1 may have a melting point of 100° C. or more, e.g., 140° C. to 220° C., and may be in solid phase at ambient temperature. In an implementation, the compound represented by Formula 1 may be synthesized by a suitable synthesis method or may include a commercially available product.

In an implementation, the compound represented by Formula 1 may have an absorbance of 0.8 AU or more, e.g., 0.8 AU to 1.0 AU, at a wavelength of 390 nm under conditions of concentration in chloroform: 10 mg/L and path length: 1 cm, and may have a maximum absorption wavelength of greater than 390 nm, e.g., greater than 390 nm and less than or equal to 400 nm or greater than 390 nm and less than 400 nm. Within these ranges, the compound represented by Formula 1 may help reduce light transmittance of the optical member through sufficient absorption of light at a wavelength of 420 nm or less, e.g., 400 nm to 420 nm, among external light incident on the optical member, thereby helping improve stability of a light emitting device against external light. Herein, “maximum absorption wavelength” refers to a wavelength at which a maximum absorption peak appears, that is, a wavelength corresponding to a maximum absorbance in an absorbance curve as a function of wavelength. Here, the “absorbance” may be measured by a suitable method.

The UV absorber may be included in an amount of, e.g., 0.1 wt % to 3 wt % in the adhesive layer, based on a total weight of the adhesive layer. Within this range, the UV absorber may help sufficiently suppress damage to a light emitting device without reduction in light transmittance of the optical member due to an excess of the UV absorber. In an implementation, the UV absorber may be included in an amount of, e.g., 0.3 wt % to 1.5 wt % in the adhesive layer, based on a total weight of the adhesive layer.

The UV absorber may be included in an amount of, e.g., 0.3 parts by weight to 3 parts by weight, e.g., 0.3 parts by weight to 1.5 parts by weight, based on a total weight of the (meth)acrylic copolymer described below. Within these ranges, the UV absorber may help ensure low light transmittance of the optical member at a wavelength of 380 nm without excessive increase in color value b* due to an excess of the UV absorber.

In an implementation, the adhesive layer may include, e.g., a pressure sensitive adhesive layer.

The (meth)acrylic copolymer may include, e.g., a non-carboxylic acid copolymer, which may not contain a carboxylic acid group. Carboxylic acid group-containing (meth)acrylic copolymers may help make the optical member less durable if the optical member is adhesively attached to a panel for optical display apparatuses.

The (meth)acrylic copolymer may include, e.g., a copolymer of a monomer mixture including an alkyl group-containing (meth)acrylic monomer having a homopolymer glass transition temperature of −40° C. or less, a monomer having a homopolymer glass transition temperature of 15° C. or more, and a hydroxyl group-containing (meth)acrylic monomer.

In an implementation, the alkyl group-containing (meth)acrylic monomer having a homopolymer glass transition temperature of −40° C. or less, the monomer having a homopolymer glass transition temperature of 15° C. or more, and the hydroxyl group-containing (meth)acrylic monomer may be included in the monomer mixture in a total amount of 99 mol % or more, e.g., 99 mol % to 100 mol or 100 mol %, based on 100 mol % of the monomer mixture. Within these ranges, the (meth)acrylic copolymer may help make it easy to achieve the desired effects of the optical member described above.

The alkyl group-containing (meth)acrylic monomer having a homopolymer glass transition temperature of −40° C. or less may help facilitate an increase in a peel strength of the adhesive layer and the formation of a matrix of the adhesive layer. In an implementation, the alkyl group-containing (meth)acrylic monomer may have a homopolymer glass transition temperature of −80° C. to −40° C.

In an implementation, the alkyl group-containing (meth)acrylic monomer may have a homopolymer glass transition temperature of −80° C. to −50° C., e.g., −80° C. to −60° C. Within these ranges, the alkyl group-containing (meth)acrylic monomer may help facilitate achievement of the desired effects of the optical member described above in combination with the (meth)acrylic monomer having a higher homopolymer glass transition temperature described below.

The alkyl group-containing (meth)acrylic monomer may include, e.g., a (meth)acrylic acid ester containing a linear or branched C₁ to C₈ alkyl group at an ester site thereof. Herein, “carbon number” refers only to the number of carbon atoms forming a main chain of the alkyl group. In an implementation, the alkyl group may have a carbon number of 6 to 8.

In an implementation, the alkyl group-containing (meth)acrylic monomer may include, e.g., n-butyl (meth)acrylate, pentyl (meth)acrylate, hexyl (meth)acrylate, 2-ethylhexyl (meth)acrylate, heptyl (meth)acrylate, octyl (meth)acrylate, or isooctyl (meth)acrylate. These compounds may be used alone or as a mixture thereof. In an implementation, the alkyl group-containing (meth)acrylic monomer may include, e.g., 2-ethylhexyl (meth)acrylate.

The alkyl group-containing (meth)acrylic monomer may be included in the monomer mixture in an amount of 65 mol % to 90 mol %, e.g., 70 mol % to 90 mol % or 70 mol % to 85 mol %, based on 100 mol % of the monomer mixture. Within these ranges, the alkyl group-containing (meth)acrylic monomer may help enhance the peel strength of the adhesive layer.

The monomer having a homopolymer glass transition temperature of 15° C. or more may be beneficial for producing the desired effects of the optical member described above.

Monomers having a homopolymer glass transition temperature of less than 15° C. may cause deterioration in optical properties of the optical member in solar testing. For example, such monomers may have a homopolymer glass transition temperature of −30° C. to −10° C.

In an implementation, the monomer having a homopolymer glass transition temperature of 15° C. or more may have a homopolymer glass transition temperature of 15° C. to 260° C., e.g., 15° C. to 210° C. Within these ranges, the monomer may help facilitate achievement of the desired effects of the optical member described above in combination with the (meth)acrylic monomer having a lower homopolymer glass transition temperature described above.

The monomer having a homopolymer glass transition temperature of 15° C. or more may include, e.g., a (meth)acrylic acid ester containing an alkyl group or a cycloaliphatic group at an ester site thereof or a maleimide containing a cycloaliphatic group or an aromatic group.

In an implementation, the (meth)acrylic acid ester having an alkyl group at an ester site thereof may include, e.g., tert-butyl (meth)acrylate or vinyl acetate. In an implementation, the (meth)acrylic acid ester containing a cycloaliphatic group at an ester site thereof may include, e.g., isobornyl (meth)acrylate, cyclohexyl (meth)acrylate, or dicyclopentadienyl (meth)acrylate. In an implementation, the maleimide containing a cycloaliphatic group may include, e.g., N-cyclohexyl maleimide or the like. In an implementation, the maleimide containing an aromatic group may include, e.g., phenyl maleimide, methyl phenyl maleimide, or the like.

The monomer having a homopolymer glass transition temperature of 15° C. or more may be included in the monomer mixture in an amount of 5 mol % to 40 mol %, e.g., 10 mol % to 30 mol % or 15 mol % to 30 mol %, based on 100 mol % of the monomer mixture. Within these ranges, the monomer may help ensure that the optical member satisfies the requirements of Equation 1 without affecting high peel strength of the adhesive layer.

The hydroxyl group-containing (meth)acrylic monomer may help enhance the peel strength of the adhesive layer through reaction with a curing agent. The hydroxyl group-containing (meth)acrylic monomer may be, e.g., a hydroxyl group-containing (meth)acrylic acid ester and may include, e.g., a (meth)acrylic acid ester containing a C₁ to C₂₀ alkyl group having one or more hydroxyl groups at an ester site thereof. In an implementation, the hydroxyl group-containing (meth)acrylic monomer may include, e.g., 2-hydroxyethyl (meth)acrylate, 2-hydroxypropyl (meth)acrylate, 2-hydroxybutyl (meth)acrylate, 4-hydroxybutyl (meth)acrylate, 6-hydroxyhexyl (meth)acrylate, or 1-chloro-2-hydroxypropyl (meth)acrylate. In an implementation, these compounds may be used alone or as a mixture thereof.

The hydroxyl group-containing (meth)acrylic monomer may be included in the monomer mixture in an amount of 0.1 mol % to 5 mol %, e.g., 0.5 mol % to 3 mol % or 0.5 mol % to 1 mol %, based on 100 mol % of the monomer mixture. Within these ranges, the hydroxyl group-containing (meth)acrylic monomer may help ensure that the optical member satisfies the requirements of Equation 1 without sacrificing mechanical strength of the adhesive layer.

The monomer mixture may be free from a long-chain alkyl group-containing (meth)acrylic acid ester. Use of the long-chain alkyl group-containing (meth)acrylic acid ester in the monomer mixture may cause inadequate cohesion and adhesion properties of the adhesive layer. Here, “long-chain alkyl group-containing (meth)acrylic acid ester” may refer to a (meth)acrylic acid ester containing a C₁₀ to C₂₅ alkyl group. Here, “carbon number” refers only to the number of carbon atoms forming a main chain of the long-chain alkyl group.

The (meth)acrylic copolymer may have a glass transition temperature of −60° C. to −10° C., e.g., −60° C. to −30° C., −60° C. to −40° C., or −60° C. to −50° C. Within these ranges, the (meth)acrylic copolymer may help facilitate achievement of the desired effects of the optical member described above.

The (meth)acrylic copolymer may have a weight average molecular weight of 500,000 g/mol to 1,500,000 g/mol, e.g., 500,000 g/mol to 1,000,000 g/mol or 600,000 g/mol to 1,000,000 g/mol. Within these ranges, the (meth)acrylic copolymer may help facilitate achievement of the desired effects of the optical member described above.

The (meth)acrylic copolymer may be prepared by polymerization of the monomer mixture by a typical polymerization method. The polymerization method may include, e.g., any suitable method. In an implementation, the (meth)acrylic copolymer may be prepared by adding an initiator to the monomer mixture, followed by a copolymer polymerization process, e.g., suspension polymerization, emulsion polymerization, solution polymerization, or the like. In an implementation, polymerization of the monomer mixture may be carried out at a temperature of 65° C. to 70° C. for 6 to 8 hours. The initiator may include, e.g., a typical initiator, including, e.g., an azo polymerization initiator or a peroxide polymerization initiator, e.g., benzoyl peroxide or acetyl peroxide.

The composition may further include a curing agent. The curing agent may help provide peel strength through a reaction with the (meth)acrylic copolymer.

The curing agent may include, e.g., a thermal curing agent. The thermal curing agent may help facilitate formation of the adhesive layer from the adhesive layer composition including the UV absorber.

The curing agent may be included in the (meth)acrylic copolymer in an amount of 0.1 parts by weight to 5 parts by weight, e.g., 0.05 parts by weight to 2.5 parts by weight, based on a total weight of the (meth)acrylic copolymer. Within these ranges, the curing agent may help ensure adhesion of the adhesive layer by inducing crosslinking of the adhesive layer composition without reduction in transparency due to an excess of the curing agent.

The thermal curing agent may include, e.g., an isocyanate curing agent, a metal chelate curing agent, an epoxy curing agent, an aziridine curing agent, an amine curing agent, or a thermal polymerization initiator. In an implementation, the thermal curing agent may include, e.g., an isocyanate curing agent or a metal chelate curing agent. In an implementation, these curing agents may be used alone or in combination thereof.

The isocyanate curing agent may be a polyfunctional, e.g., bifunctional to hexafunctional, isocyanate curing agent, and may include, e.g., xylene diisocyanate (XDI) including m-xylene diisocyanate or the like, methylene bis(phenyl isocyanate) (MDI) including 4,4′-methylenebis(phenyl isocyanate) or the like, naphthalene diisocyanate, tolylene diisocyanate, hexamethylene diisocyanate, or isophorone diisocyanate, or an adduct thereof.

The metal chelate curing agent may include, e.g., a coordination compound of a polyvalent metal, e.g. as aluminum. In an implementation, the metal chelate curing agent may include, e.g., an aluminum chelate compound, e.g., aluminum tris(ethylacetoacetate), aluminum ethylacetoacetate diisopropylate, aluminum tris(acetylacetonate), or the like.

The adhesive layer composition may include, e.g., a solvent. The solvent may help improve coatability of the adhesive layer composition while helping prevent self-curing of the adhesive layer composition. The solvent may include, e.g., a suitable solvent. In an implementation, the solvent may include, e.g., methyl ethyl ketone, ethyl acetate, or toluene.

The adhesive layer composition may further include, e.g., a silane coupling agent, a reworking agent, a curing catalyst, or an antistatic agent.

The silane coupling agent may help provide better adhesion of the adhesive layer to an adherend, e.g., glass. The silane coupling agent may include, e.g., a suitable silane coupling agent. In an implementation, the silane coupling agent may include, e.g., silicon compounds having an epoxy structure, e.g., 3-glycidoxypropyltrimethoxysilane, 3-glycidoxypropylmethyldimethoxysilane, 2-(3,4-epoxycyclohexyl)ethyltrimethoxysilane, or the like; polymerizable unsaturated group-containing silicon compounds, e.g., vinyltrimethoxysilane, vinyltriethoxysilane, (meth)acryloxypropyltrimethoxysilane, or the like; amino group-containing silicon compounds, e.g., 3-aminopropyltrimethoxysilane, N-(2-aminoethyl)-3-aminopropyltrimethoxysilane, N-(2-aminoethyl)-3-aminopropylmethyldimethoxysilane, or the like; and 3-chloropropyltrimethoxysilane. The silane coupling agent may be included in an amount of 0.001 parts by weight to 5 parts by weight, e.g., 0.001 parts by weight to 3 parts by weight, relative to a total weight of the (meth)acrylic copolymer. Within these ranges, the silane coupling agent may help ensure good durability of the adhesive layer while reducing changes in composition and properties of the adhesive layer over time.

The reworking agent may help improve reworkability of the adhesive layer and may include, e.g., a polysiloxane oligomer or a mixture including the polysiloxane oligomer. The reworking agent may be included in the (meth)acrylic copolymer in an amount of 0.001 parts by weight to 5 parts by weight, e.g., 0.005 parts by weight to 1 part by weight, relative to a total weight of the (meth)acrylic copolymer. Within these ranges, the reworking agent may help improve reworkability of the adhesive layer without affecting the properties of the adhesive layer.

The antistatic agent may help inhibit generation of static electricity during reworking of the adhesive layer and may include, e.g., a suitable antistatic agent. The antistatic agent may be included in an amount of 0.001 parts by weight to 5 parts by weight, e.g., 0.1 parts by weight to 5 parts by weight, relative to a total weight of the (meth)acrylic copolymer. Within these ranges, the antistatic agent may help provide antistatic properties without affecting the properties of the adhesive layer.

The curing catalyst may include, e.g., boron compounds, e.g., a boron trifluoride complex, e.g., an etherate of boron trifluoride, a tetrahydrofuran complex of boron trifluoride (BF₃-THF), or an aniline complex of boron trifluoride (BF₃-aniline), e.g., boron trifluoride dimethyl etherate (BF₃·O(CH₃)₂) or boron trifluoride diethyl etherate (BF₃·O(C₂H₅)₂); phosphine compounds, e.g., triphenylphosphine, tributylphosphine, tri(p-methylphenyl)phosphine, tri(nonylphenyl)phosphine, triphenylphosphine/triphenylborate, tetraphenylborate, or the like; secondary or tertiary amine compounds, e.g., an α-tertiary amine compound (e.g., KH-30, Kukdo Chemical Co., Ltd.), e.g., triethylamine, benzydiethylamine, benzydimethylamine, or the like; imidazole compounds, e.g., 2-methylimidazole, 2-phenylimidazole, 2-phenyl-4-methylimidazole, or the like; or sulfonic acid compounds, e.g., paratoluene sulfonic acid, dodecyl benzene sulfonic acid, naphthalene sulfonic acid, naphthalene disulfonic acid, methane sulfonic acid, methane disulfonic acid, phenol sulfonic acid, or the like. The curing catalyst may be included in the (meth)acrylic copolymer in an amount of 0.01 parts by weight to 5 parts by weight, e.g., 0.05 parts by weight to 2 parts by weight, relative to a total weight of the (meth)acrylic copolymer. Within these ranges, the curing catalyst may help shorten the time required to complete curing.

The adhesive layer composition may further include suitable additives. The additives may include, e.g., antioxidants, adhesion imparting resins, plasticizers, or the like. The additives may be included in the (meth)acrylic copolymer in an amount of 0.001 parts by weight to 5 parts by weight, e.g., 0.01 parts by weight to 1 part by weight, based on a total weight of the (meth)acrylic copolymer. Within these ranges, the additives may help provide intended effects without affecting the properties of the adhesive layer.

The adhesive layer composition may have a viscosity of 1,000 cP to 4,000 cP at 25° C. Within these ranges, the adhesive layer composition may allow easy adjustment of the thickness of the adhesive layer, may help ensure that the adhesive layer is free from stains, and may help ensure an even coating surface.

The adhesive layer may have a thickness of 100 μm or less, e.g., 5 μm to 50 μm. Within these ranges, the adhesive layer may be used in an optical display apparatus.

The adhesive layer may be formed by coating the adhesive layer composition to a predetermined thickness, drying the coated composition, and aging the dried composition in a constant temperature and humidity chamber at a temperature of 25° C. to 35° C. and a relative humidity of 30% to 60%.

### Transmittance Control Layer

The transmittance control layer may be between the adhesive layer and the base film to help provide color conversion. In this regard, the transmittance control layer may include, e.g., a dye mixture including, e.g., a first dye having a maximum absorption wavelength of 400 nm to 440 nm, a second dye having a maximum absorption wavelength of 480 nm to 520 nm, a third dye having a maximum absorption wavelength of 570 nm to 610 nm, and a fourth dye having a maximum absorption wavelength of 650 nm to 700 nm.

In an implementation, the first dye, the second dye, the third dye, and the fourth dye may be included in the dye mixture in a total amount of 95 wt % or more, e.g., 95 wt % to 100 wt % or 100 wt %, based on a total weight of the dye mixture.

The first dye has a maximum absorption wavelength of 400 nm to 440 nm and may help provide reduction in reflectance and improvement in screen quality. In an implementation, the first dye may have a maximum absorption wavelength of 420 nm to 440 nm, e.g., 430 nm to 440 nm.

The first dye may include, e.g., a dialkoxy group-substituted porphyrin dye. In an implementation, the dialkoxy group-substituted porphyrin dye may include, e.g., a dye represented by Formula 2:

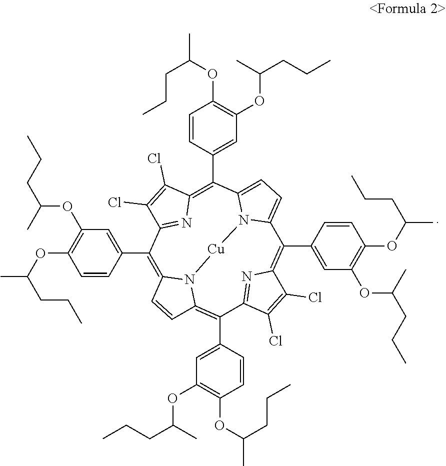

The dialkoxy group-substituted porphyrin dye may be included in the first dye in an amount of 95 wt % or more, e.g., 95 wt % to 100 wt % % or 100 wt %, based on a total weight of the first dye. Within this range, the first dye may help facilitate achievement of the desired effects of the optical member described above.

The first dye may be included in the transmittance control layer in an amount of 0.001 wt % to 5 wt %, e.g., 1 wt % to 5 wt %, 0.1 wt % to 2 wt %, or 1 wt % to 2 wt %, based on a total weight of the transmittance control layer. Within these ranges, the first dye may help provide an increase in transmittance and a reduction in reflectance in combination with the other dyes in the transmittance control layer.

The second dye may have a maximum absorption wavelength of 480 nm to 520 nm and may help provide a reduction in reflectance and an improvement in screen quality. In an implementation, the second dye may have a maximum absorption wavelength of 490 nm to 520 nm, e.g., 490 nm to 510 nm.

The second dye may include, e.g., a substituted boron dipyrromethene (BODIPY) dye. In an implementation, the substituted BODIPY dye may have a maximum absorption wavelength of 500 nm to 520 nm, e.g., 500 nm to 510 nm.

In an implementation, the substituted BODIPY dye may include, e.g., a compound represented by Formula 3:

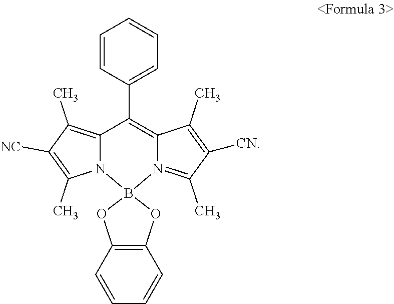

The substituted BODIPY dye may be included in the second dye in an amount of 60 wt % or more, e.g., 60 wt % to 90 wt % %, based on a total weight of the second dye. Within these ranges, the second dye may help provide the intended effects.

The second dye may further include an additional dye having a different maximum absorption wavelength than the substituted BODIPY dye. The additional dye may have a lower maximum absorption wavelength than the substituted BODIPY dye. In an implementation, the dye may have a maximum absorption wavelength of greater than or equal to 480 nm and less than 500 nm. In an implementation, the dye may be included in the second dye in an amount of 40 wt % or less, e.g., 10 wt % to 40 wt %, based on a total weight of the second dye. Within these ranges, the dye may help provide the intended effects.

According to one embodiment, the substituted BODIPY dye and the additional dye having a different maximum absorption wavelength than the substituted BODIPY dye may be included in the second dye in a total amount of 95 wt % or more, e.g., 95 wt % to 100 wt % or 100 wt %, based on a total weight of the second dye.

The second dye may be included in the transmittance control layer in an amount of 0.001 wt % to 5 wt %, e.g., 0.1 wt % to 5 wt %, 0.1 wt % to 2 wt %, or 1 wt % to 2 wt %, based on a total weight of the transmittance control layer. Within these ranges, the second dye may help provide an increase in transmittance and a reduction in reflectance in combination with the other dyes in the transmittance control layer.

The third dye may have a maximum absorption wavelength of 570 nm to 610 nm and may help provide reduction in reflectance and improvement in screen quality. In an implementation, the third dye may include, e.g., a mixture of four dyes having different maximum absorption wavelengths.

The third dye may include, e.g., a tetraazaporphyrin dye. In an implementation, the tetraazaporphyrin dye may have a maximum absorption wavelength of 590 nm to 600 nm, e.g., 590 nm to 596 nm.

In an implementation, the tetraazaporphyrin dye may be included in the third dye in an amount of 10 wt % to 50 wt %, e.g., 10 wt % to 40 wt % or 10 wt % to 30 wt %, based on a total weight of the third dye. Within these ranges, the third dye may help provide the intended effects.

The third dye may further include a dye having a different maximum absorption wavelength than the tetraazaporphyrin dye.

In an implementation, the third dye may further include a mixture of a dye having a maximum absorption wavelength of greater than or equal to 570 nm and less than 580 nm, a dye having a maximum absorption wavelength of greater than or equal to 580 nm and less than 590 nm, and a dye having a maximum absorption wavelength of greater than 600 nm and less than or equal to 610 nm. In an implementation, in the third dye, the dye having a maximum absorption wavelength of greater than or equal to 570 nm and less than 580 nm may be included in an amount of 10 wt % to 50%, e.g., 10 wt % to 40 wt % or 20 wt % to 40%, the dye having a maximum absorption wavelength of greater than or equal to 580 nm and less than 590 nm may be included in an amount of 10 wt % to 50%, e.g., 10 wt % to 40 wt % or 10 wt % to 30%, and the dye having a maximum absorption wavelength of greater than 600 nm and less than or equal to 610 nm may be included in the third dye in an amount of 10 wt % to 50%, e.g., 10 wt % to 50 wt % or 10 wt % to 30%, based on a total weight of the third dye. Within these ranges, the third dye may help provide the intended effects to ensure the desired effects of the optical member described above.

In an implementation, the tetraazaporphyrin dye and the dye having a different maximum absorption wavelength than the tetraazaporphyrin dye may be included in the third dye in a total amount of 95 wt % or more, e.g., 95 wt % to 100 wt % or 100 wt %, based on a total weight of the third dye.

The third dye may be included in the transmittance control layer in an amount of 0.001 wt % to 5 wt %, e.g., 0.1 wt % to 5 wt %, 1 wt % to 5 wt % or 2 wt % to 5 wt %, based on a total weight of the transmittance control layer. Within these ranges, the third dye may help provide an increase in transmittance and a reduction in reflectance in combination with the other dyes in the transmittance control layer.

The fourth dye may have a maximum absorption wavelength of 650 nm to 700 nm and may help provide reduction in reflectance and improvement in screen quality. In an implementation, the fourth dye may have a maximum absorption wavelength of, e.g., 650 nm to 690 nm, 650 nm to 680 nm, or 660 nm to 680 nm.

The fourth dye may include, e.g., a sulfonamide group-substituted copper complex dye. In an implementation, the sulfonamide group-substituted copper complex dye may include, e.g., a dye represented by Formula 4:

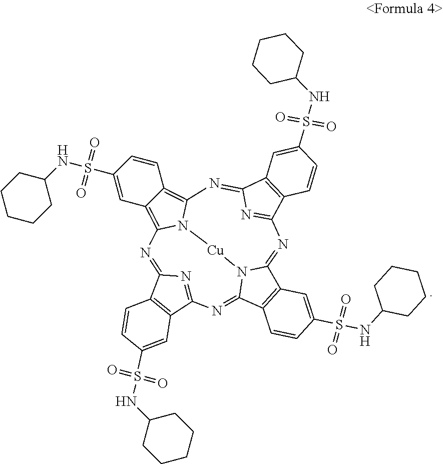

The sulfonamide group-substituted copper complex dye may be included in the fourth dye in an amount of 95 wt % or more, e.g., 95 wt % to 100 wt % or 100 wt %, based on a total weight of the fourth dye. Within these ranges, the fourth dye may help facilitate achievement of the desired effects of the optical member described above.

The fourth dye may be included in the transmittance control layer in an amount of 0.001 wt % to 5 wt %, e.g., 0.1 wt % to 5 wt %, 0.1 wt % to 2 wt %, or 1 wt % to 2 wt %, based on a total weight of the transmittance control layer. Within these ranges, the fourth dye may help provide an increase in transmittance and a reduction in reflectance in combination with the other dyes in the transmittance control layer.

The dye mixture including the first dye, the second dye, the third dye, and the fourth dye may be included in the transmittance control layer in an amount of 3 wt % to 15 wt %, e.g., 3 wt % to 10 wt % or 5 wt % to 10 wt %, based on a total weight of the transmittance control layer. Within these ranges, the dye mixture may help provide a reduction in reflectance and improvement in screen quality.

The dye mixture may degrade if exposed to UV light for a long period of time under repeated temperature changes between ambient temperature and high temperature. Degradation of the dye mixture may cause a significant increase in light transmittance variation ΔT(λ) according to Equation 1.

The transmittance control layer may include, e.g., a (meth)acrylic copolymer, wherein the (meth)acrylic copolymer may be a copolymer of a monomer mixture including 50 mol % to 90 mol % of an alkyl group-containing (meth)acrylic monomer and 10 mol % to 50 mol % of an aromatic group-containing (meth)acrylic monomer, based on 100 mol % of the monomer mixture.

The (meth)acrylic copolymer contained in the transmittance control layer may help ensure that the dye mixture contained in the transmittance control layer does not suffer degradation even if exposed to UV light for a long period of time under repeated temperature changes between ambient temperature and high temperature, thereby providing significant reduction in light transmittance variation ΔT(λ) according to Equation 1.

According to one embodiment, the alkyl group-containing (meth)acrylic monomer and the aromatic group-containing (meth)acrylic monomer may be included in the monomer mixture in a total amount of 95 mol % or more, e.g., 95 mol % to 100 mol %, 98 mol % to 100 mol %, or 100 mol %, based on 100 mol % of the monomer mixture.

The alkyl group-containing (meth)acrylic monomer may include, e.g., (meth)acrylic acid ester containing a linear or branched C₁ to C₁₀ alkyl group. In an implementation, the (meth)acrylic acid ester may include, e.g., methyl (meth)acrylate, ethyl (meth)acrylate, propyl (meth)acrylate, n-butyl (meth)acrylate, t-butyl (meth)acrylate, isobutyl (meth)acrylate, pentyl (meth)acrylate, hexyl (meth)acrylate, 2-ethylhexyl (meth)acrylate, heptyl (meth)acrylate, n-octyl (meth)acrylate, isooctyl (meth)acrylate, nonyl (meth)acrylate, or decyl (meth)acrylate.

In an implementation, the (meth)acrylic acid ester may have a homopolymer glass transition temperature of 50° C. or more, e.g., 50° C. to 150° C. Within these ranges, the (meth)acrylic acid ester may help minimize variations in luminance and reflectance. In an implementation, the (meth)acrylic acid ester may include, e.g., methyl methacrylate.

The alkyl group-containing (meth)acrylic monomer may be included in the monomer mixture in an amount of 50 mol % to 90 mol %, based on 100 mol % of the monomer mixture. Within these ranges, the (meth)acrylic acid ester may help protect the dye mixture and may minimize variations in luminance and reflectance in solar testing.

The aromatic group-containing (meth)acrylic monomer may include, e.g., a (meth)acrylic acid ester containing a C₆ to C₂₀ aryl group, a C₇ to C₂₀ arylalkyl group, a C₆ to C₂₀ aryloxy group, or a C₇ to C₂₀ arylalkoxy group at an ester site thereof.

According to an implementation, the aromatic group-containing (meth)acrylic monomer may have a homopolymer glass transition temperature of 5° C. or more, e.g., 5° C. to 50° C. Within these ranges, the aromatic group-containing (meth)acrylic monomer may help minimize variations in luminance and reflectance.

In an implementation, the aromatic group-containing (meth)acrylic monomer may include, e.g., a (meth)acrylic acid ester containing two or more aromatic groups at an ester site thereof. This feature may be advantageous in protecting the dye mixture and minimizing variations in luminance and reflectance in solar testing. In an implementation, the two or more aromatic groups may include, e.g., biphenyl groups. The (meth)acrylic acid ester may include, e.g., biphenylylmethyl (meth)acrylate.

The aromatic group-containing (meth)acrylic monomer may be included in the monomer mixture in an amount of 10 mol % to 50 mol %, based on 100 mol % of the monomer mixture. Within these ranges, the aromatic group-containing (meth)acrylic monomer may help protect the dye mixture and may help minimize variations in luminance and reflectance in solar testing.

The (meth)acrylic copolymer may have a glass transition temperature of 35° C. to 70° C., e.g., 38° C. to 68° C. Within these ranges, the (meth)acrylic copolymer may help make it easy to achieve the desired effects of the optical member described above.

The (meth)acrylic copolymer may have a weight average molecular weight of 100,000 g/mol to 500,000 g/mol, e.g., 200,000 g/mol to 500,000 g/mol. Within these ranges, the (meth)acrylic copolymer may help make it easy to achieve the desired effects of the optical member described above. Here, the “weight average molecular weight” may be obtained using gel permeation chromatography (GPC) based on a polystyrene standard.

The (meth)acrylic copolymer may be prepared from the monomer mixture by a suitable polymerization method.

The transmittance control layer may have a thickness of 0.1 μm to 10 μm, e.g., 1 μm to 5 μm. Within these ranges, the transmittance control layer may be used in the optical member.

### Base Film

The base film may be on the transmittance control layer to help protect the adhesive layer and the transmittance control layer and to help enhance mechanical strength of the optical member. In an implementation, the base film may be directly on the transmittance control layer. Here, “directly formed” means that no other adhesive layer or bonding layer is interposed between the base film and the transmittance control layer.

In an implementation, the base film may have a light transmittance of 80% or more, e.g., 90% to 99%, at a wavelength of 500 nm to 800 nm. Within these ranges, the base film may help enhance luminous efficacy by not affecting an optical path of external light or internal light transmitted through the optical member.

In an implementation, the base film may have a light transmittance of 1% or less, e.g., 0.1% to 1% at a wavelength of 380 nm.

The base film may include, e.g., an optically clear protective film or an optically clear protective coating layer.

If the base film is of the protective film type, the base film may include, e.g., a protective film including an optically clear resin. The protective film may be formed by melt extrusion of the resin. If necessary, the resin may be further subjected to a stretching process. The resin may include, e.g., cellulose ester resins including triacetylcellulose or the like, cyclic polyolefin resins including an amorphous cyclic olefin polymer (COP) or the like, polycarbonate resins, polyester resins including polyethylene terephthalate (PET) or the like, polyethersulfone resins, polysulfone resins, polyamide resins, polyimide resins, non-cyclic polyolefin resins, polyacrylate resins including polymethyl methacrylate or the like, polyvinyl alcohol resins, polyvinyl chloride resins, or polyvinylidene chloride resins.

If the base film is of the protective coating layer type, the base film may have good properties in terms of adhesion to the adhesive layer, transparency, mechanical strength, thermal stability, moisture barrier capacity, or durability. In an implementation, the protective coating layer as the base film may include, e.g., an actinic radiation-curable resin composition including an actinic radiation-curable compound and a polymerization initiator.

The actinic radiation-curable compound may include, e.g., cationic polymerizable curable compounds, radical polymerizable curable compounds, urethane resins, or silicone resins. The cationic polymerizable curable compound may include, e.g., an epoxy compound containing at least one epoxy group in a molecular structure thereof or an oxetane compound containing at least one oxetane ring in a molecular structure thereof. The radical polymerizable curable compound may include, e.g., a (meth)acrylic compound containing at least one (meth)acryloyloxy group in a molecular structure thereof.

The base film may have a thickness of 5 μm to 200 μm, e.g., 30 μm to 120 μm or 50 μm to 100 μm (in the case of the protective film type) or 5 μm to 50 μm (in the case of the protective coating layer type). Within these ranges, the base film may be used in an optical display apparatus.

In an implementation, the base film may be free from a functional coating layer, e.g., an antireflection layer, on one surface thereof.

FIG. 1 is a cross-sectional view of an optical member according to one embodiment.

Referring to FIG. 1, the optical member may include, e.g., an adhesive layer 100, a transmittance control layer 200, and a base film 300 sequentially on an upper surface of the adhesive layer 100. The optical member may further include a release film on a lower surface of the adhesive layer 100.

In accordance with an embodiment, an optical display apparatus is provided.

The optical display apparatus may include, e.g., the optical member described above.

In an implementation, the optical display apparatus may include, e.g., a panel for the optical display apparatus and the optical member formed on the panel.

In an implementation, the optical display may be free from a polarizing plate. With the optical member capable of replacing the function of a polarizing plate, the optical display apparatus may prevent damage to a light emitting device, despite the absence of a polarizing plate.

The optical display apparatus may include, e.g., liquid crystal displays, light emitting device displays, e.g., organic light emitting device displays, or the like.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Preparative Example 1: Preparation of (Meth)Acrylic Copolymer

First, 50 g of toluene was placed in a 500 mL reactor provided with a reflux condenser for easy temperature control and a nitrogen gas inlet. Thereafter, 100 parts by weight of a monomer mixture including monomers listed in Table 1 in amounts listed in Table 1 was added to the reactor. Thereafter, nitrogen gas was introduced into the reactor for 30 minutes to purge oxygen from the reactor and to remove oxygen from the monomer mixture, followed by maintaining the internal temperature of the reactor at 70° C. After the monomer mixture was thoroughly stirred, 0.06 parts by weight of V601 (dimethyl 2,2′-azobis(2-methylpropionate)) as an initiator and a chain extender was added to the reactor and the internal temperature of the reactor was increased to 75° C., followed by reaction for 4 hours. After further reaction at 75° C. for 2 hours, the reactor was cooled to ambient temperature, followed by addition of toluene, thereby preparing a solution containing 35 wt % of a (meth)acrylic copolymer. The weight average molecular weight and glass transition temperature of the prepared (meth)acrylic copolymer were respectively obtained by GPC and DSC analyses.

### Preparative Examples 2 to 7: Preparation of (Meth)Acrylic Copolymer

(Meth)acrylic copolymers were prepared in the same manner as in Example 1 except that the type and content of each monomer in the monomer mixture were changed as listed in Table 1 and the content of the initiator or reaction time was changed. In Table 1, “−” means that the content of a corresponding component is 0 mol %.

### Preparative Example 8: IF850 NP (LG Chemical) was Used as a (Meth)Acrylic Copolymer

TABLE 1

| Preparative | | | | |
|---|---|---|---|---|
| Example | MMA | BPMA | Mw | Tg |
| 1 | 100 | 0 | 166,561 | 100 |
| 2 | 95 | 5 | 328,650 | 77.66 |
| 3 | 90 | 10 | 240,079 | 65.47 |
| 4 | 80 | 20 | 457,148 | 51.47 |
| 5 | 70 | 30 | 460,986 | 46.02 |
| 6 | 50 | 50 | 317,991 | 38.48 |
| 7 | 30 | 70 | 385,200 | 35.29 |
| 8 | — | — | 87,021 | 100 |

*In Table 1, MMA: Methyl methacrylate (homopolymer Tg: 105° C., Sigma-Aldrich Chemical Co., Inc.) and BPMA: 4-biphenylylmethyl acrylate (homopolymer Tg: 6° C., M1192, Miwon Chemical Co., Ltd.).

Details of components used in Examples and Comparative Examples are as follows:
(A) (Meth)acrylic copolymer: (Meth)acrylic copolymers prepared in Preparative Examples 1 to 8 (see Table 1).
(B) Dye
(B1) VP-40 (maximum absorption wavelength: 431 nm, dialkoxy group-substituted porphyrin dye, synthesized by the inventors, represented by the formula below)

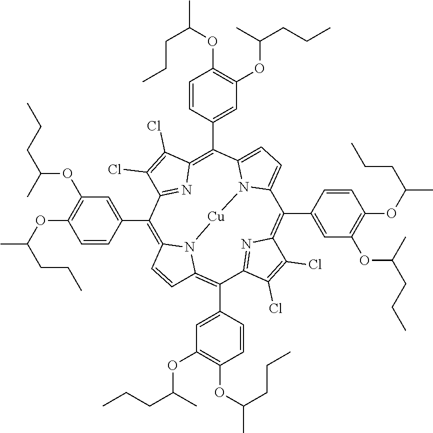

(B2) FDB-022 (maximum absorption wavelength: 493 nm, Yamada chemical Co., Ltd.)
(B3) CD30 (maximum absorption wavelength: 506 nm, substituted BODIPY dye, synthesized by the inventors, represented by the formula below)

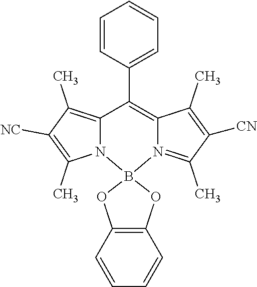

(B4) FDG-004 (maximum absorption wavelength: 576 nm, Yamada chemical Co., Ltd.)
(B5) AMC 581 (maximum absorption wavelength: 581 nm, AMC Corp.)
(B6) KIS-001 (maximum absorption wavelength: 593 nm, tetraazaporphyrin dye, Kyungin Synthetic Co., Ltd.)
(B7) FDR-001 (maximum absorption wavelength: 604 nm, Yamada chemical Co., Ltd.)
(B8) RP-Cu-01 (maximum absorption wavelength: 676 nm, sulfonamide group-substituted copper complex dye, synthesized by the inventors, represented by the formula below)

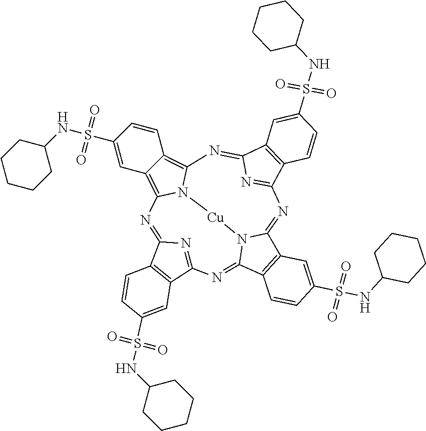

The (meth)acrylic copolymer of Preparative Example 2 was dissolved at a concentration of 35 wt % in toluene. Each of dyes (B1) to (B8) was dissolved at a concentration of 1 wt % to 5 wt % in methyl ethyl ketone or toluene. The resulting solutions were mixed in amounts listed in Table 2 in terms of solid content, thereby preparing a transmittance control layer composition.

### Example 1

TABLE 2

| Absorption | | |
|---|---|---|
| wavelength of dye | | Parts by |
| (unit: nm) | Component | weight |
| | (Meth)acrylic | 91.6 |
| | copolymer | |
| 431 | (B1) VP-40 | 1.12 |
| 493 | (B2) FDB-022 | 0.65 |
| 506 | (B3) CD30 | 1.02 |
| 576 | (B4) FDG-004 | 1.38 |
| 581 | (B5) AMC 581 | 0.93 |
| 593 | (B6) KIS-001 | 0.93 |
| 604 | (B7) FDR-001 | 1.25 |
| 676 | (B8) RP-Cu-01 | 1.12 |

The prepared transmittance control layer composition was deposited to a predetermined thickness on a lower surface of a base film (triacetylcellulose film, thickness: 40 μm, PG402S, Hyosung Chemical Co., Ltd.), followed by drying at 120° C. for 2 minutes, thereby forming a transmittance control layer (thickness: 3.2 μm) on the lower surface of the base film.

An acrylic copolymer (free from carboxylic acid groups, CI-247, SOKEN Chemical Co., Ltd.) was mixed with a UV absorber (UA-3912, Orient Chemical Co., Ltd.), an isocyanate curing agent (TD-75, SOKEN Chemical Co., Ltd.), a crosslinking catalyst (Sn catalyst (DBTDL)), an adhesion enhancer (CK-500), and a silane coupling agent (A-50), followed by stirring with a mechanical stirrer for 20 minutes. Thereafter, the resulting mixture was degassed for 40 minutes, thereby preparing an adhesive layer composition. The content of each component in the adhesive layer composition is shown in Table 3.

TABLE 3

| Component | Content (g) |
|---|---|
| CI-247 | 87.06 |
| TD-75 | 0.08 |
| Sn catalyst | 0.01 |
| A-50 | 0.22 |
| CK-500 | 12 |
| UA-3912 | 0.63 |

The prepared adhesive layer composition was deposited to a predetermined thickness on one surface of a release film (thickness: 38 μm), dried at 100° C. for 4 minutes, covered with a triacetylcellulose film (thickness: 50 μm), and aged at 35° C. and 45% RH for 2 days, thereby manufacturing a stack of release film/adhesive layer (thickness: 15 μm)/triacetylcellulose film.

Thereafter, only the adhesive layer was attached to a lower surface of the transmittance control layer, thereby manufacturing an optical member.

### Examples 2 to 4

Optical members were manufactured in the same manner as in Example 1 except that the type of (meth)acrylic copolymer in the transmittance control layer composition was changed as listed in Table 4.

### Comparative Examples 1 to 4

Optical members were manufactured in the same manner as in Example 1 except that the type of (meth)acrylic copolymer in the transmittance control layer composition was changed as listed in Table 5.

Each of the optical members manufactured in Examples and Comparative Examples was evaluated as to the properties listed in Table 4 and Table 5. Results are shown in Table 4, Table 5, FIG. 2, and FIG. 3. In FIG. 2 and FIG. 3, the solid line indicates light transmittance after solar testing and the dotted line indicates initial light transmittance.

### (1) Color Coordinates of Optical Member

Using a light transmittance measuring instrument (V-650 UV-spectrometer, JASCO Corp.), brightness L, color value a*, and color value b* of each of the manufactured optical members under a D65 light source were determined from a transmittance spectrum of the optical member.

### (2) Reflectance of Optical Member

After each of the manufactured optical members was attached to a mobile OLED panel through the adhesive layer of the optical member, reflectance was measured in a reflection mode and in an SCI mode using a spectrophotometer (CM-3600a, Konica Minolta Inc.).

### (3) Estimated Luminous Efficacy

The luminous efficacy of a panel was estimated using a film transmittance spectrum measured for each of the optical members manufactured in the Examples and Comparative Examples. A luminance ratio of the optical member to a polarizing film was calculated under the assumption that a typical polarizing film has a transmittance of 50%.

P(λ): OLED spectrum of FIG. 2, y(λ): Spectrum of each of the optical members manufactured in Examples and Comparative Examples

$$\begin{matrix}Estimated luminous efficacy = ( A / B ) * 100 \\ A = {\int }_{450}^{470} P ( λ ) \times y ( λ ) d λ + {\int }_{520}^{550} P ( λ ) \times y ( λ ) d λ + {\int }_{610}^{637} P ( λ ) \times y ( λ ) d λ \\ B = ( {\int }_{450}^{470} P ( λ ) d λ + {\int }_{520}^{550} P ( λ ) d λ + {\int }_{610}^{637} P ( λ ) 0.5 d λ ) \times \frac{1}{2}\end{matrix}$$

### (4) Initial Light Transmittance of Optical Member

Each of the manufactured optical members was cut to a size of 25 mm×200 mm (width×length) and then attached to a glass plate, there preparing a specimen. Light transmittance of the specimen was measured in the wavelength range of 300 nm to 800 nm using a light transmittance measuring instrument (V-650 UV-spectrometer, JASCO Corp.). Light transmittances at 405 nm, 493 nm, and 585 nm were obtained from the measurement results.

### (5) Solar Test

Each of the manufactured optical members was cut to a size of 25 mm×200 mm (width×length) and then attached to a glass plate, thereby preparing a specimen. The prepared specimen was placed in a UV chamber and irradiated with 340 nm UV light under the following conditions:

Solar test conditions: A total of 500 hours of multicycle light irradiation treatment (1 cycle being defined as irradiating the specimen with 340 nm UV light at an irradiance of 0.35 W/m² while leaving the specimen at 25° C. for 4 hours and at 63° C. for 8 hours).

Thereafter, the specimen was removed from the UV chamber and then left at ambient temperature for 30 minutes, followed by obtaining light transmittances at 405 nm, 493 nm, and 585 nm in the same manner as in (4). An absolute value of the difference in light transmittance ΔT of the specimen before and after the solar test was calculated.

TABLE 4

| | | | Example 1 | Example 2 | Example 3 | Example 4 |
|---|---|---|---|---|---|---|
| (Meth)acrylic copolymer | | | Preparative | Preparative | Preparative | Preparative |
| | | | Example 3 | Example 4 | Example 5 | Example 6 |
| Thickness of transmittance control layer (μm) | | | 3.2 | 3.4 | 3.5 | 3.4 |
| Panel | Color | L | 56.66 | 54.04 | 53.34 | 53.68 |
| characteristics | coordinates | a* | 5.4 | 6.41 | 8.23 | 7.9 |
| | | b* | −8.2 | −8.28 | −8.43 | −7.89 |
| | Reflectance | 4.3 to 9.2 | 4.86 | 4.43 | 4.31 | 4.37 |
| | Estimated | 119% to | 122% | 120% | 119% | 119% |
| | luminous | 150% | | | | |
| | efficacy | | | | | |
| Light | 0 hr | 405 nm | 13.92 | 14.19 | 13.73 | 12.73 |
| transmittance | | 493 nm | 7.10 | 5.65 | 5.75 | 5.81 |
| (%) | | 585 nm | 4.39 | 3.36 | 3.34 | 3.54 |
| | 500 hr | 405 nm | 16.07 | 16.15 | 15.85 | 14.91 |
| | | 493 nm | 12.75 | 10.31 | 10.39 | 10.48 |
| | | 585 nm | 5.63 | 4.41 | 4.37 | 4.74 |
| | ΔT | 405 nm | 2.15 | 1.96 | 2.12 | 2.18 |
| | | 493 nm | 5.65 | 4.66 | 4.64 | 4.67 |
| | | 585 nm | 1.24 | 1.06 | 1.03 | 1.20 |

TABLE 5

| | | | Comparative | Comparative | Comparative | Comparative |
|---|---|---|---|---|---|---|
| | | | Example 1 | Example 2 | Example 3 | Example 4 |
| | | | Preparative | Preparative | Preparative | Preparative |
| | | | Example 8 | Example 1 | Example 2 | Example 7 |
| Thickness of transmittance control layer | | | 2.5 | 2.3 | 3.2 | 3.4 |
| (μm) | | | | | | |
| Panel | Color | L | 66.21 | 69.04 | 62.12 | 58.67 |
| characteristics | coordinates | a* | 0.57 | 0.49 | 2.03 | 3.67 |
| | | b* | −5.82 | −5.97 | −6.55 | −7.33 |
| | Reflectance | 4.3 to 9.2 | 6.63 | 7.20 | 5.84 | 5.21 |
| | Estimated | 119% to | 132% | 134% | 128% | 124% |
| | luminous | 150% | | | | |
| | efficacy | | | | | |
| Light | 0 hr | 405 | 16.47 | 18.09 | 15.32 | 14.29 |
| transmittance | | 493 | 15.89 | 18.33 | 12.85 | 9.06 |
| (%) | | 585 | 10.66 | 13.93 | 8.15 | 5.52 |
| | 500 hr | 405 | 19.13 | 20.78 | 17.35 | 16.58 |
| | | 493 | 28.33 | 30.36 | 21.26 | 16.45 |
| | | 585 | 14.46 | 17.19 | 10.69 | 7.55 |
| | ΔT | 405 | 2.66 | 2.69 | 2.03 | 2.29 |
| | | 493 | 12.45 | 12.03 | 8.41 | 7.39 |
| | | 585 | 3.80 | 3.26 | 2.54 | 2.03 |

As can be seen from Table 4, the optical members of Examples had a low light transmittance variation at a wavelength of 400 nm to 600 nm even after long-term exposure to UV light, and thus could improve reliability of a display apparatus. Further, the optical members of Examples provided a reflectance of 4% to 9.5%, as measured on a panel, and thus could improve screen quality. Moreover, the optical members of Examples showed a significantly small difference between light transmittances at 0 hours and 500 hours at a given wavelength, as shown in FIG. 2.

Conversely, as can be seen from Table 5, the optical members of Comparative Examples had a high light transmittance variation at a wavelength of 400 nm to 600 nm after long-term exposure to UV light. In addition, the optical members of Comparative Examples showed a significantly large difference between light transmittances at 0 hours and 500 hours at a given wavelength, as shown in FIG. 3.

By way of summation and review, with the trend toward reduction in thickness of optical display apparatuses, development of an optical display apparatus without a polarizing plate (pol-less optical display apparatus) has been ongoing. However, in such a pol-less optical display apparatus a light emitting device may be directly exposed to external light and thus may be prone to damage.

Present embodiments provide an optical member that may have a low light transmittance variation at a wavelength of 400 nm to 600 nm even after long-term exposure to UV light under repeated temperature changes between ambient temperature and high temperature, thereby improving reliability of a display apparatus.

Present embodiments provide an optical member that may provide a reflectance of 4% to 9.5%, as measured on a panel for display apparatuses, thereby improving screen quality.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An optical member, comprising:
an adhesive layer; and
a transmittance control layer and a base film sequentially on an upper surface of the adhesive layer,
wherein:
the transmittance control layer includes a (meth)acrylic copolymer and a dye mixture,
the dye mixture includes a first dye having a maximum absorption wavelength of 400 nm to 440 nm, a second dye having a maximum absorption wavelength of 480 nm to 520 nm, a third dye having a maximum absorption wavelength of 570 nm to 610 nm, and a fourth dye having a maximum absorption wavelength of 650 nm to 700 nm, and
the (meth)acrylic copolymer is a copolymer of a monomer mixture including 50 mol % to 90 mol % of an alkyl group-containing (meth)acrylic monomer and 10 mol % to 50 mol % of an aromatic group-containing (meth)acrylic monomer, all mol % being based on 100 mol % of the monomer mixture.

2. The optical member as claimed in claim 1, wherein the alkyl group-containing (meth)acrylic monomer and the aromatic group-containing (meth)acrylic monomer are included in a total amount of 95 mol % or more, based on 100 mol % of the monomer mixture.

3. The optical member as claimed in claim 1, wherein the alkyl group-containing (meth)acrylic monomer has a homopolymer glass transition temperature of 50° C. or more.

4. The optical member as claimed in claim 1, wherein the aromatic group-containing (meth)acrylic monomer has a homopolymer glass transition temperature of 5° C. or more.

5. The optical member as claimed in claim 1, wherein the aromatic group-containing (meth)acrylic monomer includes a (meth)acrylic acid ester containing two or more aromatic groups at an ester site thereof.

6. The optical member as claimed in claim 5, wherein the two or more aromatic groups are biphenyl groups.

7. The optical member as claimed in claim 1, wherein the (meth)acrylic copolymer is a copolymer of methyl (meth)acrylate and biphenylylmethyl (meth)acrylate.

8. The optical member as claimed in claim 1, wherein the (meth)acrylic copolymer has a glass transition temperature of 35° C. to 70° C.

9. The optical member as claimed in claim 1, wherein the (meth)acrylic copolymer has a weight average molecular weight of 100,000 g/mol to 500,000 g/mol.

10. The optical member as claimed in claim 1, wherein the first dye includes a dialkoxy group-substituted porphyrin dye.

11. The optical member as claimed in claim 1, wherein the second dye includes a substituted boron dipyrromethene dye.

12. The optical member as claimed in claim 1, wherein the third dye includes a tetraazaporphyrin dye.

13. The optical member as claimed in claim 1, wherein the fourth dye includes a sulfonamide group-substituted copper complex dye.

14. The optical member as claimed in claim 1, wherein the dye mixture including the first dye, the second dye, the third dye, and the fourth dye is included in an amount of 3 wt % to 15 wt %, based on a total weight of the transmittance control layer.

15. The optical member as claimed in claim 1, wherein the transmittance control layer includes 0.001 wt % to 5 wt % of the first dye, 0.001 wt % to 5 wt % of the second dye, 0.001 wt % to 5 wt % of the third dye, and 0.001 wt % to 5 wt % of the fourth dye, all wt % being based on a total weight of the transmittance control layer.

16. The optical member as claimed in claim 1, wherein the transmittance control layer has a thickness of 0.1 μm to 10 μm.

17. The optical member as claimed in claim 1, wherein the base film is free from an antireflection layer.

18. The optical member as claimed in claim 1, wherein the adhesive layer includes a UV absorber.

19. An optical display apparatus comprising the optical member as claimed in claim 1.

20. The optical display apparatus as claimed in claim 19, wherein the optical display apparatus is free from a polarizing plate.
